(19) United States
(12) Patent Application Publication
(10) Pub. No.: US 2006/0243828 A1
(43) Pub. Date: Nov. 2, 2006

(54) Sprinkler valve manifold system

(76) Inventor: Dino R. Angelone, Tehachapi, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/124,734

(22) Filed: May 2, 2005

(51) Int. Cl. B05B 15/10; B05B 1/14; B05B 1/30

(52) U.S. Cl. 239/569; 239/207; 239/565

(57) ABSTRACT

A sprinkler valve manifold system for use with sprinkler systems and the like that is configured with a sprinkler manifold connected to a supply of water, one or more operatively controlled sprinkler control valves and a piping system having a plurality of sprinklers to distribute water to areas of vegetation. Quick release connectors are connectedly disposed between the sprinkler control valve and the manifold and between the sprinkler control valve and the piping system to allow the sprinkler control valve to be easily and quickly removed from the manifold system for repair or replacement of the sprinkler control valve. Use of the quick release connectors with the manifold system of the present invention eliminates the need to remove the entire manifold to remove a single sprinkler valve and substantially reduces the time and effort to effectuate such repair or replacement of sprinkler valves.

### CROSS-REFERENCE TO RELATED APPLICATIONS

None.

### BACKGROUND OF THE INVENTION

A. Field of the Invention

The field of the present invention relates generally to water distribution systems such as sprinkler systems and the like. More particularly, the present invention relates to water distribution systems having a valve manifold system and one or more water control valves connected to the valve manifold. Even more particularly, the present invention relates to sprinkler valve manifold systems that are configured for ease of installation and removal of the sprinkler control valves disposed therein.

B. Background

Water distribution systems utilizing various pipes, valves, manifolds and related water distribution components are well known and commonly used for numerous water distribution purposes. One common purpose for such systems is to distribute water from a supply of water, such as municipal water systems or private wells, to a sprinkler system used to water lawns, gardens, plants, trees and/or other vegetation. The typical sprinkler system has a manifold that is hydraulically connected to the supply of water to distribute the water to one or more sprinkler control valves disposed on the manifold. The sprinkler control valves are configured to distribute water through sprinkler pipes to sprinklers located near or in the vegetation to deliver the water in a controlled, timed manner. To facilitate control of the distribution of the water, the sprinkler control valves of the typical sprinkler system are electrically connected to a controller unit so that the user can modify to selectively distribute water from the manifold through the sprinkler control valves to the sprinklers. Numerous types of sprinkler control valves are commonly available from a variety of different sprinkler valve manufacturers and suitable for use with standard sprinkler systems.

Generally, the piping system connecting to the source of water and the piping system delivering water from the sprinkler control valves to the sprinkler heads are substantially located below the surface of the ground so as to avoid or help prevent damage from lawn mowers, hoes, shovels, rakes and other lawn/garden treating equipment and to reduce the likelihood of damage from freezing surface temperatures. Because it is not uncommon to need access to the manifold to repair or replace broken or damaged sprinkler control valves mounted thereon, the typical sprinkler system is configured with the manifold and sprinkler valves located in an open or openable manifold box or other area that is somewhat accessible from the ground surface. Although various materials can be utilized for sprinkler manifolds, control valves and pipes, perhaps the most common material is a plastic or plastic-like material do to the generally corrosion resistant and durable nature of the material. To provide the desired water-tight system, the sprinkler control valves are securely mounted between the sprinkler manifold and the pipes leading to the sprinklers.

While the typical sprinkler system may operate for many years without needing repair or replacement, either due to malfunction or upgrading, of one or more of the sprinkler control valves, it is not unusual for such work to be required. Because the sprinkler control valves are fixedly attached to the manifold and piping system, a homeowner, plumber or other repair person must remove the entire sprinkler manifold in order to repair or replace the sprinkler control valve or valves that need, or are desired to be, repaired or replaced. The net effect of the current configuration of sprinkler valve manifold systems is that the need to repair or replace one sprinkler control valve results in having to replace the entire sprinkler valve manifold. Naturally, this requires greater time and cost than would be necessary if the valve manifold system was configured to facilitate the removal and replacement of a single sprinkler control valve. In addition, due to the difficulty associated with removing and replacing the manifold, the typical homeowner or handyman is usually not able to accomplish the repair/replacement on his or her own and must engage the services of a professional plumber. What is needed, therefore, is a sprinkler valve manifold system that is configured to allow removal of a single sprinkler control valve from the sprinkler manifold without having to remove the manifold itself from the sprinkler valve manifold system. The preferred sprinkler valve manifold system should allow the user to selectively and easily remove one or more sprinkler control valves from the manifold, without requiring removal or modification of the manifold, so the sprinkler control valve can be repaired, upgraded or replaced as desired. The preferred sprinkler valve manifold system should be adaptable for use with virtually all types of sprinkler control valves and piping systems utilized in sprinkler systems.

### SUMMARY OF THE INVENTION

The sprinkler valve manifold system of the present invention solves the problems and provides the benefits identified above. That is to say, the present invention discloses a sprinkler valve manifold system that is used to interconnect the water supply system with the sprinkler piping system and allow the relatively quick and easy replacement of one or more sprinkler control valves from the sprinkler manifold without requiring removal or modification of the manifold itself. The sprinkler valve manifold system of the present invention is adaptable to sprinkler manifolds having one or more sprinkler control valves and to virtually all types of sprinkler control valves and sprinkler piping systems. The sprinkler valve manifold system of the present invention solves the problems associated with having to remove and replace the entire sprinkler valve manifold when it is merely necessary or desirable to remove one or more of the sprinkler control valves. With the present invention, the user can quickly and easily remove a damaged or obsolete sprinkler control valve and replace it with a repaired or new sprinkler control valve. Because this work can be done without having to remove the sprinkler manifold, it can be accomplished with significantly less time and for substantially lower costs than is obtainable with the present configuration of sprinkler valve manifold systems. As such, the present invention is a significant improvement over the prior art sprinkler valve manifold systems.

In one general aspect of the present invention, the sprinkler valve manifold system of the present invention has a manifold with an inlet port and one or more outlet ports. The inlet port is connected to a supply line that is hydraulically connected to a supply of pressurized water, such as a municipal water system or a well, to deliver water through a sprinkler piping with a plurality of sprinklers disposed therein for distributing water over a vegetated area, such as a lawn, garden or the like. A sprinkler control valve is operatively disposed on the manifold to selectively allow pressurized water to flow from the manifold through the piping system to the sprinklers. The inlet of the sprinkler control valve is hydraulically connected to one of the outlet ports of the manifold and the outlet of the sprinkler control valve is hydraulically connected to the sprinkler piping. A first quick release connector interconnects the outlet of the manifold and the inlet of the sprinkler control valve and a second quick release connector interconnects the outlet of the sprinkler control valve and the sprinkler piping. In the preferred embodiment of the present invention, both the first and second quick release connectors are of the same configuration. Both the first quick release connector and the second quick release connector are operatively configured to allow the sprinkler control valve to be easily and quickly removed from the sprinkler valve manifold system. The quick release connectors can be made to be removably connected, using threaded ends adapters or like components to threadably engage cooperatively configured components on the manifold, sprinkler control valve and/or piping system, or they can be made integral with the manifold, sprinkler control valve and/or piping system.

A variety of different types of sprinkler control valves and number of different configurations quick release connectors are adaptable to the sprinkler valve manifold system of the present invention. As an example, the sprinkler control valve can be of the in-line type or raised anti-syphon type. The quick release connector can comprise a male connector component that is configured to be releasably engaged by a female connector component. In one such configuration the male connector component has an outwardly extending portion that is configured to be sealably engaged in an internal cavity in the female connector component. A slidable engagement member on the female connector component can be configured to releasably engage the outwardly extending portion of the male connector component in the internal cavity.

Accordingly, the primary objective of the present invention is to provide a sprinkler valve manifold system that provides the advantages discussed above and that overcomes the disadvantages and limitations associated with presently utilized sprinkler valve manifold systems.

It is also an object of the present invention to provide a sprinkler valve manifold system that comprises a manifold which receives water from a source of water and distributes the water to one or more easily detachable and removable sprinkler control valves mounted thereon that are configured to distribute water in a controlled, typically timed manner, to one or more sprinklers through the attached sprinkler piping system.

It is also an object of the present invention to provide a sprinkler valve manifold system with one or more sprinkler control valves each having two quick release type of connectors thereon to interconnect the sprinkler control valve with the manifold and the sprinkler piping system.

It is also an object of the present invention to provide a sprinkler valve manifold system configured with opposing components of a quick release connector interconnecting the manifold and sprinkler control valve and interconnecting the sprinkler control valve and the sprinkler piping system so the sprinkler control valve can be quickly and easily removed from the sprinkler valve manifold system without having to remove or alter the sprinkler manifold.

The above and other objectives of the present invention will be explained in greater detail by reference to the attached figures and the description of the preferred embodiment which follows. As set forth herein, the present invention resides in the novel features of form, construction, mode of operation and/or combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top plan view of a sprinkler system having a sprinkler valve manifold system configured according to the present invention to interconnect the water supply and sprinkler piping systems;

FIG. 2 is an isolated plan view of the sprinkler valve manifold system of the present invention showing one of the sprinkler control valves of FIG. 1 with a pair of quick release connectors attached thereto to allow relatively easy removal thereof;

FIG. 3 is a side view of a quick release mechanism configured for use with the sprinkler valve manifold system of the present invention;

FIG. 4 is a top plan view of a sprinkler system having a sprinkler valve manifold system configured according to the present invention connected to a standard anti-syphon type of sprinkler control valve; and

FIG. 5 is a side view of a sprinkler system having a sprinkler valve manifold system configured according to the present invention connected to a shut-off type of sprinkler control valve.

### DETAILED DESCRIPTION OF THE PREFERRED EMBODIMENTS

With reference to the figures where like elements have been given like numerical designations to facilitate the reader's understanding of the present invention, and particularly with reference to the embodiment of the sprinkler valve manifold system of the present invention illustrated in the figures, various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

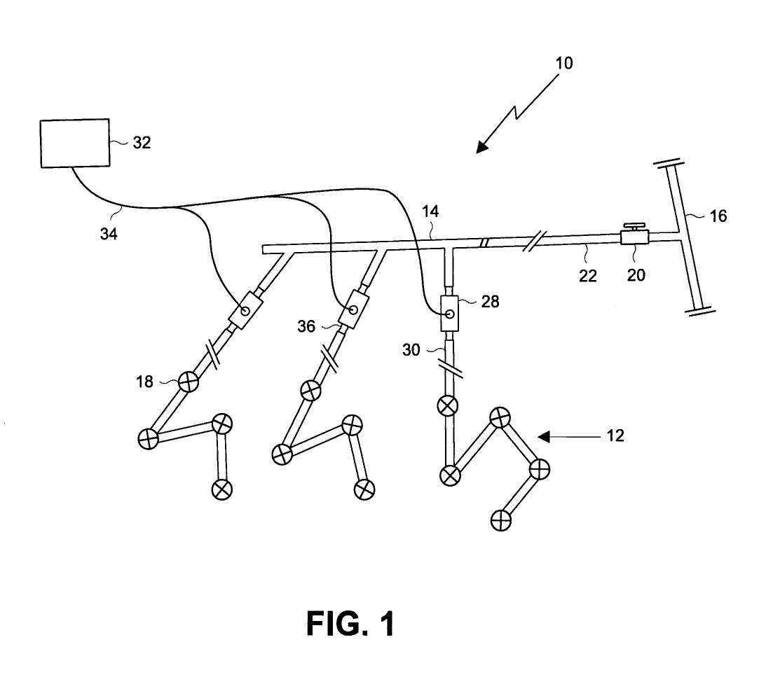

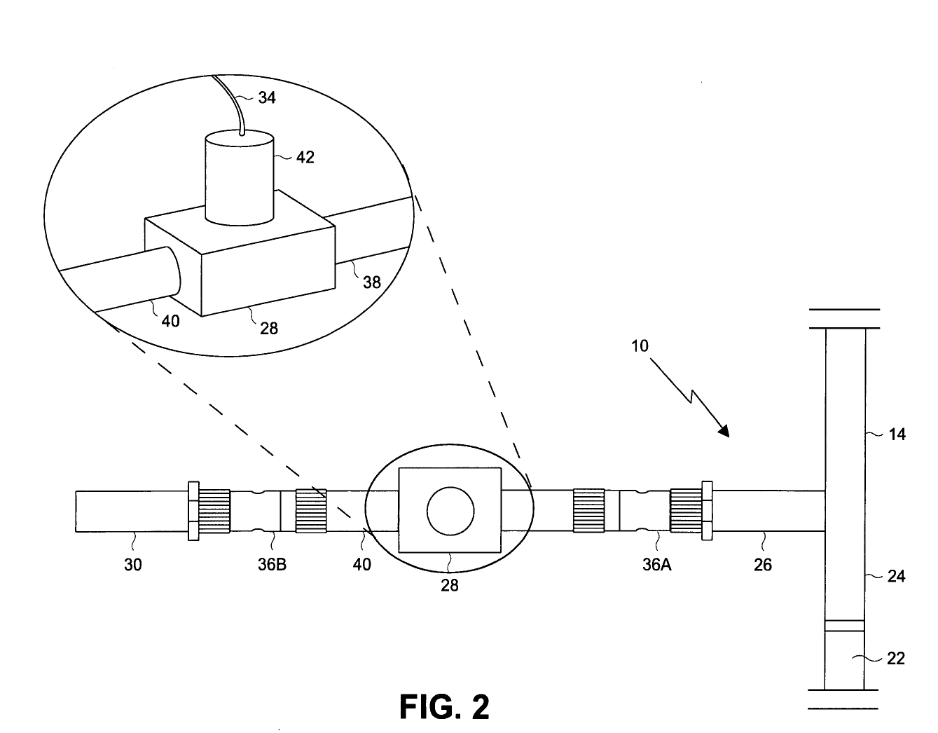

A preferred embodiment of the sprinkler valve manifold system of the present invention, shown in the figures and identified generally as 10, is best shown in FIG. 2. As explained in more detail below and shown installed in a sprinkler system 12 in FIG. 1, sprinkler valve manifold system 10, having sprinkler manifold 14, is utilized in sprinkler system 12 that is configured to distribute water from a pressurized supply of water 16, such as a municipal water supply system, well or other source of water, and one or more, typically a plurality of, sprinklers 18 used to water a lawn, garden, plants or other vegetation (not shown). As known to those skilled in the art, the typical sprinkler system 12 has a water shut-off valve 20 disposed in the supply line 22 between the supply of water 16 and the sprinkler manifold 14 to allow the pressurized water to be shut off during the installation or repair of the other components in sprinkler system 12. Supply line 22 connects to inlet port 24 of sprinkler manifold 14. One or more outlet ports 26 on sprinkler manifold 14 are each configured for attachment to a sprinkler control valve 28. Sprinkler control valve 28 is hydraulically connected to sprinkler piping 30 so as to selectively and controllably deliver water from manifold 14 to sprinklers 18. As shown in FIG. 1, sprinkler system 12 can be configured such that the sprinklers 18 are grouped in sets and are arranged to water in zones so as to more effectively utilize the available water pressure and rate (gpm). Typically, each sprinkler zone is controlled by a single sprinkler control valve 28, each of which is electrically connected to a controller 32 by electrical wire 34 that attaches to a solenoid component of sprinkler control valve 28. The standard controller 32 is configured to water the desired vegetation area by cycling through the various sprinkler zones by selectively controlling the operation of sprinkler control valves 28. Although the embodiment shown in FIG. 1 is shown with three manifold outlet ports 26 and sprinkler control valves 28 attached thereto, those skilled in the art will know that sprinkler valve manifold system 10 can be configured with one or more outlet ports 26, typically each with a single sprinkler control valve 28 attached thereto, and any number of sprinklers 18 as may be desired to obtain the desired sprinkler coverage of the vegetation area within the limits of the pressure and rate capacity of the supply of water 16.

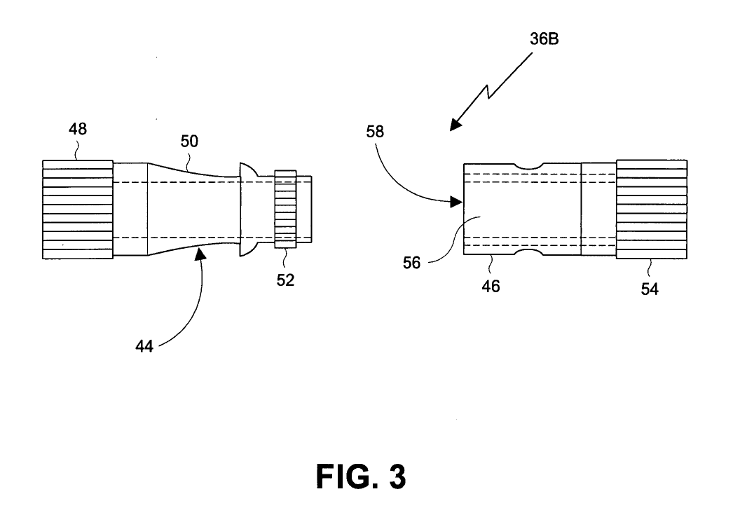

As discussed above, the heretofore standard sprinkler valve manifold system utilizes sprinkler control valves 28 that are fixedly attached to the outlet ports 26 of manifold 14 and fixedly attached to sprinkler piping 30. Typically, the manifold 14, piping components of sprinkler control valve 28 and the sprinkler piping 30 are made out of PVC or other plastic or plastic-type material and a bonding agent is utilized to chemically bond the components together to prevent leaks of the pressurized water. As such, when it becomes necessary to remove one of the sprinkler control valves 28 from manifold 14, so that so that valve 28 may be repaired or replaced, the user was generally required to remove the entire manifold 14 from the system. This requirement results in much wasted time and money. As set forth in more detail below, the sprinkler valve manifold system 10 of the present invention utilizes quick release connectors 36, best shown in FIGS. 2 and 3, at the inlet port 38 and outlet port 40 of sprinkler control valve 28 to allow a person to quickly and easily remove sprinkler control valve 28 from sprinkler control manifold system 10. Use of quick release connectors 36 eliminates the need to remove manifold 14 from sprinkler valve manifold system 10 and allows the selective removal of one or more of the sprinkler control valves 28 (of which there may be ten, fifteen or more in some installations).

One frequently utilized type of sprinkler control valve 28 for sprinkler systems 12, referred to as an in-line valve, is shown in FIG. 2 with the sprinkler valve manifold system 10 of the present invention. The in-line sprinkler control valve 28 is typically installed below ground. If the supply of water 16 is also used as a drinking water source, then most municipal codes require the use of a separate backflow prevention device (not shown) to prevent possible contamination of the drinking water supply. The selective operation of sprinkler control valve 28 is controlled by controller 32, which is connected by electrical wire 34 to the solenoid portion 42 of sprinkler control valve 28. As shown in FIG. 2, sprinkler control valve 28 is bounded by two quick release connectors 36, shown as 36a at its inlet 38 and 36b at its outlet 40. In the embodiment shown in FIG. 2, first quick release connector 36a interconnects outlet 26 of manifold 14 and inlet 38 of sprinkler control valve 28 and second quick release connector 36b interconnects the outlet 40 of sprinkler control valve 28 and sprinkler piping 30 leading to the plurality of sprinklers 18. As explained in more detail below, quick release connectors 36 are operated so as to easily and quickly remove sprinkler control valve 28 from sprinkler valve manifold system 10.

A number of different types of quick release connectors 36 are suitable for use with the sprinkler valve manifold system 10 of the present invention. For purposes of discussion with regard to the operation and benefits of the present invention, one such quick release connector 36 is described in detail herein as being exemplary of a type of such connector 36. However, the present invention is not intended to be limited to the quick release connector 36 described herein. Those skilled in the art will readily recognize that a number of commonly available configurations of quick release connectors 36 will be suitable for use with the sprinkler valve manifold system 10 of the present invention. In addition, it is anticipated that new quick release connectors 36 will become commercially available that will also be adaptable to the present invention. The improvement presented by the sprinkler valve manifold system 10 of the present invention is the use of any such quick release connectors 36 in a sprinkler valve manifold system 10 to allow the quick and easy removal of one or more sprinkler control valves 28 from the manifold 14 as may be necessary or desirable to effectuate the removal thereof for repair or replacement.

A quick release connector 36 found to be suitable for use with the sprinkler valve manifold system 10 of the present invention is commercially available from Gardena of Newcastle upon Tyne, Great Britain and is identified as the Profi' Maxi-Flow System Connector Set (product code 1505-23) as of the filing of the present application. This particular quick release connector 36, shown in FIG. 3 as 36b, comprises a male connector 44 and a cooperatively configured female connector 46. The male connector 44 is configured with an internally threaded first end 48 and an outwardly extending portion 50 having a sealing member 52, such as an o-ring, disposed near the distal end thereof. The female connector 46 is configured with an internally threaded second end 54, a slidable engagement member 56 and an internal cavity 58 configured to operatively receive outwardly extending portion 50 of male connector 44 therein. As will be appreciated by those skilled in the art, the internal cavity 58 of female connector 46 has a plurality of engagement prongs (not shown) circumferentially disposed about inside of internal cavity 58. The engagement prongs are released by sliding slidable engagement member 56 to the right (in FIG. 3) so outwardly extending portion 50 can be inserted inside internal cavity 58 and then placed into engagement by releasing or sliding slidable engagement member 56 to the left (in FIG. 3) to cause the engagement prongs to securely engage outwardly extending portion 50. Sealing member 52 seals against the inside of internal cavity 58. In FIG. 2, the internally threaded first end 48 of male connector 44 engages external threads (not shown) on the end of sprinkler piping 30 and the internally threaded second end 54 of female connector 46 engages external threads (not shown) on outlet 40 of sprinkler control valve 28. By sliding slidable engagement member 56 to the right (in FIG. 3) the user can allow outwardly extending portion 50 to be inserted into or removed from internal cavity 58 so as to connect or disconnect second quick release connector 36b and facilitate the removal of sprinkler control valve 28 from sprinkler valve manifold system 10 of the present invention. The embodiment of FIG. 2 shows a like configured first quick release connector 36a, the use of a pair of quick release connectors 36 being the preferred configuration, at the inlet 38 of sprinkler control valve 28 to connect with the outlet port 26 of manifold 14. The ease of removal of sprinkler control valve 28 from a sprinkler manifold 14 accomplished by the present invention has not heretofore been available for sprinkler valve manifold systems.

A number of modifications are possible to quick release connectors 36 and the other components of the sprinkler valve manifold system 10 of the present invention without departing from the scope and spirit of the present invention. For instance, the relative placement of the male connector 44 and female connector 46 portions of quick release connectors 36 can be reversed from that described above. In addition, the first 48 and second 54 ends of quick release connectors 36 can be externally threaded or configured to fixedly (i.e., with bonding agent) attach to outlet port 26 of manifold 14, inlet 38 and outlet 40 of sprinkler control valve 28, and sprinkler piping 30. Alternatively, the ends 48 and 54 of quick release connectors 36 can be integral with these components to reduce the number of connections to only two, the two locations where the outwardly extending portions 50 would be received inside internal cavity 58. As also known to those skilled in the art, engagement mechanisms other than the slidable engagement member 56 and internal prongs can be utilized with quick release connectors 36. As stated above, the improvement presented by the present invention is the use of quick release connectors 36 in a sprinkler valve manifold system 10 to allow the quick and easy removal of one or more sprinkler control valves 28 from the manifold 14 as may be necessary or desirable to effectuate the removal thereof for repair or replacement and not to a specific type of quick release connector 36.

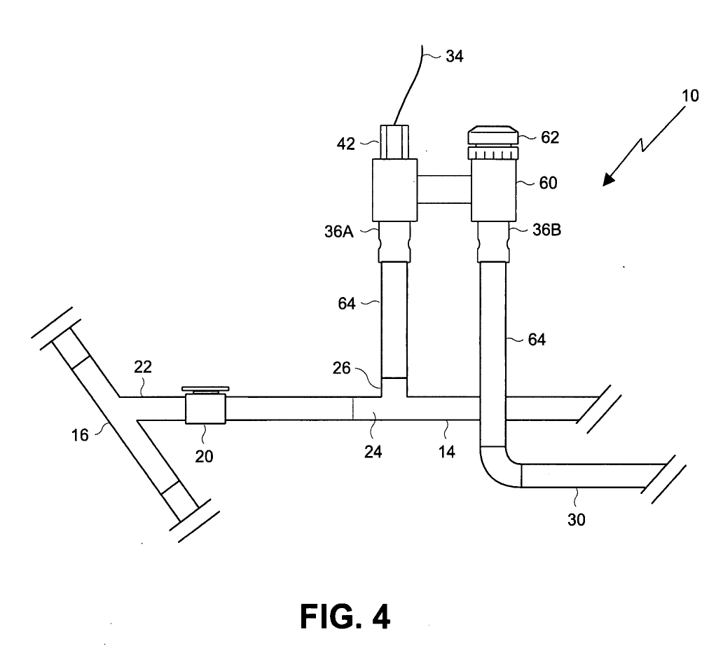

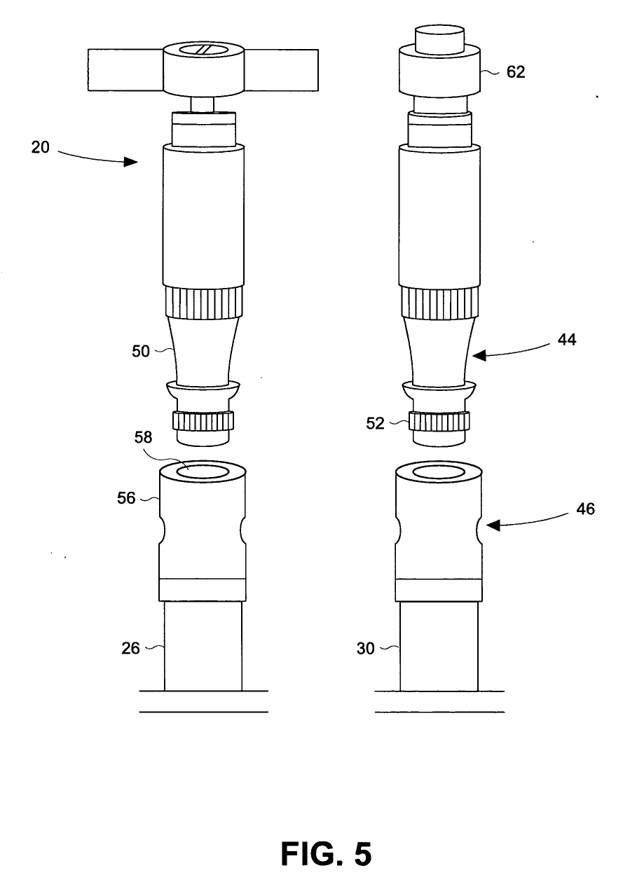

The sprinkler valve manifold system 10 of the present invention is also not limited to the in-line type of valve shown in FIG. 2. For instance, as shown in FIG. 4, the present invention is also adaptable for use with commercially available anti-syphon valves, shown as 60, that have a solenoid 42 and a built-in backflow preventing device 62. As shown in FIG. 4, this type of valve 60 is typically installed on risers 64 configured to place the valve 60 a specified minimum distance above the elevation of the highest sprinkler 18. Quick release connector 36a interconnects the inlet of valve 60 and the riser 64 that connects to the outlet port 26 of manifold 14 and quick release connector 36b interconnects the outlet of valve 60 and riser 64 that connects to sprinkler piping 30. When necessary or desired to remove anti-syphon valve 60 from sprinkler manifold system 10, the user only needs to operate quick release connectors 36a and 36b to disengage valve 60 from the sprinkler manifold system 10. In addition, as shown in FIG. 5, sprinkler manifold system 10 can also be utilized to isolate a shut-off valve 20 or other valves utilized in sprinkler system 12 so that the user can easily and quickly replace those valves as needed. In the embodiment shown in FIG. 5, the components of quick release connectors 36 are shown as integral with valve 20, shown in use with a backflow preventing device 62.

When installed in new sprinkler systems 12 or retrofitted to an existing sprinkler system 12, the sprinkler valve manifold system 10 of the present invention provides for the quick and easy removal of the water control valves, such as in-line sprinkler valve 28, anti-syphon valve 60 or shut-off valve 20 (collectively sprinkler valve 28). When it is desired or necessary to replace sprinkler valve 28 in the sprinkler valve manifold system 10 of the present invention, the user merely has to operate quick release connectors 36 to disengage the sprinkler valve 28 from the sprinkler manifold 14 and then reverse the procedure for installing a repaired or new sprinkler valve 28 therein. As will be recognized by those skilled in the art, use of sprinkler valve manifold system 10 of the present invention can substantially reduce the amount of time and money to effectuate repair or replacement of sprinkler valves 28.

While there are shown and described herein certain specific alternative forms of the present invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to assembly, materials, size, shape and use. In addition, the present invention is subject to modification with regard to the types of control valves, quick release connectors and other components suitable for use with the present invention.

What is claimed is:

1. A sprinkler valve manifold system, comprising:
a manifold having an inlet port and one or more outlet ports, said inlet port connected to a supply line connected to a supply of pressurized water;
a sprinkler piping having one or more sprinklers disposed therein for distributing water;
a sprinkler control valve having an inlet and an outlet, said inlet of said sprinkler control valve hydraulically connected to one of said one or more outlet ports of said manifold, said outlet of said sprinkler control valve hydraulically connected to said sprinkler piping, said sprinkler control valve configured to selectively allow the flow of pressurized water from said manifold to said one or more sprinklers; and
a first quick release connector interconnecting said outlet of said manifold and said inlet of said sprinkler control valve; and
a second quick release connector interconnecting said outlet of said sprinkler control valve and said sprinkler piping,
whereby said first quick release connector and said second quick release connector are operatively configured to allow said sprinkler control valve to be easily and quickly removed from said sprinkler valve manifold system.

2. The sprinkler valve manifold system according to claim 1, wherein said first quick release connector is removably connected to said outlet of said manifold and said inlet of said sprinkler control valve, and said second quick release connector is removably connected to said outlet of said sprinkler control valve and said sprinkler piping.

3. The sprinkler valve manifold system according to claim 1, wherein said first quick release connector is integral with said outlet of said manifold and said inlet of said sprinkler control valve, and said second quick release connector is integral with said outlet of said sprinkler control valve and said sprinkler piping.

4. The sprinkler valve manifold system according to claim 1, wherein each of said first quick release connector and said second quick release connector comprise a male connector and a female connector, said male connector configured to be releasably engaged to said female connector.

5. The sprinkler valve manifold system according to claim 4, wherein said male connector has an outwardly extending portion configured to be sealably engaged in an internal cavity in said female connector.

6. The sprinkler valve manifold system according to claim 5, wherein said quick release connector has a slidable engagement member configured to releasably engage said outwardly extending portion in said internal cavity.

7. A sprinkler valve manifold system, comprising:
a manifold having an inlet port and one or more outlet ports, said inlet port connected to a supply line connected to a supply of pressurized water;
a sprinkler piping having one or more sprinklers disposed therein for distributing water;
a sprinkler control valve having an inlet and an outlet, said inlet of said sprinkler control valve hydraulically connected to one of said one or more outlet ports of said manifold, said outlet of said sprinkler control valve hydraulically connected to said sprinkler piping, said sprinkler control valve configured to selectively allow the flow of pressurized water from said manifold to said one or more sprinklers; and
a pair of quick release connectors, one of said pair of quick release connectors interconnecting said outlet of said manifold and said inlet of said sprinkler control valve and one of said pair of quick release connectors interconnecting said outlet of said sprinkler control valve and said sprinkler piping,
whereby said pair of quick release connectors are operatively configured to allow said sprinkler control valve to be easily and quickly removed from said sprinkler valve manifold system.

8. The sprinkler valve manifold system according to claim 7, wherein each of said first quick release connector and said second quick release connector comprise a male connector and a female connector, said male connector configured to be releasably engaged to said female connector.

9. The sprinkler valve manifold system according to claim 8, wherein said male connector has an outwardly extending portion configured to be sealably engaged in an internal cavity in said female connector.

10. The sprinkler valve manifold system according to claim 9, wherein said quick release connector has a slidable engagement member configured to releasably engage said outwardly extending portion in said internal cavity.

11. A sprinkler valve manifold system, comprising:
a manifold having an inlet port and one or more outlet ports, said inlet port connected to a supply line connected to a supply of pressurized water;
a sprinkler piping having one or more sprinklers disposed therein for distributing water; and
a sprinkler control valve having an inlet and an outlet, said inlet of said sprinkler control valve hydraulically connected to one of said one or more outlet ports of said manifold with a first quick release connector, said outlet of said sprinkler control valve hydraulically connected to said sprinkler piping with a second quick release connector, said first quick release connector integral with said inlet of said sprinkler control valve, said second quick release connector integral with said outlet of said sprinkler control valve, said sprinkler control valve configured to selectively allow the flow of pressurized water from said manifold to said one or more sprinklers,
whereby said first quick release connector and said second quick release connector are operatively configured to allow said sprinkler control valve to be easily and quickly removed from said sprinkler valve manifold system.

12. The sprinkler valve manifold system according to claim 11, wherein each of said first quick release connector and said second quick release connector comprise a male connector and a female connector, said male connector configured to be releasably engaged to said female connector.

13. The sprinkler valve manifold system according to claim 12, wherein said male connector has an outwardly extending portion configured to be sealably engaged in an internal cavity in said female connector.

14. The sprinkler valve manifold system according to claim 13, wherein said quick release connector has a slidable engagement member configured to releasably engage said outwardly extending portion in said internal cavity.
